(19) United States
(12) Patent Application Publication
(10) Pub. No.: US 2015/0024487 A1
(43) Pub. Date: Jan. 22, 2015

(54) CRYOPRESERVATION STORAGE DEVICE FOR CELL COLLECTION BAG, AND USING METHOD THEREOF

(71) Applicant: Steminent Biotherapeutics, Inc., Taipei City (TW)

(72) Inventors: Cheng-Yi CHENG, Taipei City (TW); Yu-Shan WU, Taipei City (TW); Yin LIANG, Taipei City (TW); Wei-Kee ONG, Taipei City (TW); Hui-Chun HO, Taipei City (TW)

(73) Assignee: Steminent Biotherapeutics, Inc., Taipei City (TW)

(21) Appl. No.: 14/150,070

(22) Filed: Jan. 8, 2014

(30) Foreign Application Priority Data
Jul. 18, 2013 (TW) 102125772

(51) Int. Cl. A01N 1/02

(52) U.S. Cl. CPC A01N 1/0284
USPC 435/374; 435/307.1

(57) ABSTRACT

The present invention relates to a cryopreservative device comprising an outer case, one or more layers of space for the cryo-bags, and two or more Teflon cryopreservative bags. The outer case has a cover lip for opening and closing. The Teflon cryopreservative bags are filled with a freezing resistant. In the present invention, the cryo-bags and the Teflon cryopreservative bags are crossly stacked in the cryopreservation device. The Teflon cryopreservative bags are designed to directly contact with the cryo-bags in order to obtain the effect of slow cell freezing.

### BACKGROUND OF THE INVENTION

1. Technical Field of the Invention

The present invention relates to a cryopreservation device which protects freezing cells in a cryo-bag against the frostbite. In particular, the cryopreservation device contains two or more Teflon cryopreservative bags filled with freezing resistant (such as 100% Isopropyl alcohol), which are stacked in contact with the cryo-bags and able to slowly decrease the temperature of the cryo-bags at constant cooling rate during the freezing process.

2. Description of related arts

When freezing cells, it is necessary to decrease the temperature slowly to avoid rapid or unstable cooling process, which may lead cell death due to condensation of water crystal within the cell. Two essential factors for successful cell freezing are: 1. Adding cryoprotectant; and 2. Optimizing the cooling rate. The cryoprotectant commonly used is Dimethyl sulfoxide (DMSO). DMSO is a small, membrane permeable molecule that can reduce the size and the amount of intracellular water crystal, and which can protect cells from freezing and thawing-induced cytotoxicity so that the survival rate of cells increased with DMSO. However, DMSO per se at a concentration higher than 10% is cytotoxic; thus, it is possible to achieve the best condition for cell cryopreservation using DMSO less than 10% with the optimal cooling rate control.

To achieve the smooth temperature descending rate, filling with 100% Isopropanol (Isopropyl alcohol) as an anti-freezing reagent in the space between the inner compartment and the outer case is the most common strategy in commercial available cryo box. The ideally cooling rate for cells in a tube is 1° C. decrease per minute down to −80° C., and cells can survive for a long time at −80° C. Isopropanol makes the cooling rate approximate −1° C./min smoothly in the cryo box and relative refrigeration apparatus. However, isopropanol is a material with high volatility and is easy to saturate with the moisture in the air, which result in progressive loss of its efficiency on temperature-controlling performance. Cryogenic tubes, manufactured in Kelowna International Technology Co., Ltd., can shorten the duration for re-usage due to a good cooling rate control without isopropanol and a rapid re-frosting rate. However, commercially available cryo-boxes (e.g. Mr. Frosty from Nalgene) only provided the cell cryopreservated in a tube, and no cryo-box for cell cryopreservated in a cryo-bag so far.

Under the regulation of Foundation for the Accreditation of Cellular Therapy (FACT), cord blood must be stored in a cryo-bag for preservation. It is commonly used in the industry to preserve the collected cord blood with a cryo preserved bag such as the one from Pall Corporation (USA). Pall cryo preserved bags is a bag with two compartmentalized segments: large one has the capacity of 20 ml, and the small one has 5 ml. The latter can be used for cell proliferation before stem cell transplantation, and then cells in the small bag are transplanted together with cells in the large bag to a patient. Cells in that bag can also be used for the treatment of damaged tissues and organs. In order to prevent cross-contamination during cryopreservation, the cryo-bag will be wrapped with another bag and then placed in an aluminum box before being placed into a computerized temperature-reducing system for programming cooling at the cooling rate of −1° C./min. For example, in U.S. Pat. No. 4,018,911 a rigid metal holder having perforated side plates for containing plastic bags of human red cells for both freezing and thawing such cells is provided, with using hydroxyethylstarch (HES) as the cryprotective agent, to permit the very fast freezing rates required to produce viable red cells. When the temperature is dropped to −80° C., the cord blood will be transferred to a liquid nitrogen tank (keeping ≦190° C. temperature) for long term preservation (more than one year).

A conventional method for cryopreservation of a living cell comprises placing the cell in a cryoprotectant; gradually cooling the living cell in cryoprotectant to a first predetermined temperature; and rapidly cooling the living cell in cryoprotectant from the first predetermined temperature to a second predetermined temperature. The step of gradually cooling the cell may include cooling at a rate of between about 1° C./min and about 3° C./min. Typically, the first predetermined temperature is about −30° C. The second predetermined temperature may be between about −80° C. and about −196° C. The rapid cooling step may be accomplished by immersing the cells in liquid nitrogen.

A computerized or well-controlled cooling system is desired to achieve a slower cooling rate allowing cryopreservation of cells without fear of damage from ice crystal formation or osmotic shock injury. US 2010/0281886 provided a system for cryopreserving a liquid biological material disposed in a bag having a longitudinal axis. The system comprises a bag holder for holding the bag, a tank containing a cryogenic fluid, a mechanism for the immersion of the bag holder into the tank along the longitudinal axis, an opening in the tank for insertion therethrough of the bag holder, and a guide member extending from the opening into the tank. U.S. Pat. No. 7,604,930 provided an apparatus for holding living cells for cooling during cryopreservation, comprising a first aluminum container for receiving and holding the living cells, and a stainless steel second container for receiving and holding the first container. The second container may be sealed around the first container to define a space between the exterior wall of the first container and the interior wall of the second container.

However, the computerized temperature-reducing system is very expensive, which makes the storage and transplantation of stem cells costly. Moreover, cooling rate at −1° C./min is ideally for freezing cells in a tube (small amount of cells), and need to be modified for storage of massive cells in cryo-bags. For a massive cell cryopreservation, −1° C./min may not be the optimal cooling rate since the survival rate of cells in cryo-bags is generally lower than that in cryo-tubes after thawing. Currently, the regulation of FDA in US defines that minimal criteria of cell survival rate for clinical use after thawing is ≧70%. Accordingly, there is a need in the art for inexpensive, reliable and convenient devices for easily cryopreserving and transferring various cell types in cryo-bags.

Polytetrafluoroethylene (PTFE) is a synthetic fluoropolymer of tetrafluoroethylene that has numerous applications. The best known brand name of PTFE is Teflon by DuPont Co. PTFE is used as a non-stick coating for pans and other cookware. It is very non-reactive, partly because of the strength of carbon-fluorine bonds, and so it is often used in containers and pipework for reactive and corrosive chemicals. Where used as a lubricant, PTFE reduces friction, wear, and energy consumption of machinery (see, for example, US 2011/190178; CN 202418014; CN 202946839). It is also commonly used as a graft material in surgical interventions (see, US 2008103352; US 2012046727). Because of its chemical inertness, PTFE cannot be cross-linked like an elastomer. Therefore, it has no “memory” and is subject to creep. PTFE grafts can be used to bypass stenotic arteries in peripheral vascular disease, if a suitable autologous vein graft is not available.

U.S. Pat. No. 6,426,214 provided a cell encapsulating devices capable of maintaining large numbers of viable cells. The enclosable cell encapsulating device comprises an outer porous polytetrafluoroethylene permeable membrane wherein said permeable membrane allows for passage into said device of nutrients external to said device and wastes of cells and desirable cell products out of said device without permitting passage of cells therethrough. JP 2007/125037 described a cell freezing and storage bag assembly, including a transfer set that can be sterilely welded to the source of the mammalian cells. The bag is constructed principally of polytetrafluoroethylene fabric, and designed to be filled to a fraction of its maximum capacity so that the cell suspension has a very thin cross-section (less than about 10 millimeters). However, the use of PTFE (referred to as Teflon in the following description) as a cryopreservative bag for filling freezing resistant, such as isopropanol, has not been disclosed so far.

### SUMMARY OF INVENTION

Currently, there is no simple cryopreservation device for cryo-bag storage under −80° C. . Thus, the cryo-bag has to be placed into an expensive, space-occupied computerized temperature-reducing system for controlling the cooling rate. Programmable cooling device requires sophisticated computer instrumentation to monitor the cooling process in detail, which makes the device and the equipment costly. In addition, fill full of liquid nitrogen is essential for cryopreservation so that a large number of expendable materials also increase the cost of using computerized temperature-reducing system. So, it is valuable to create and design a cost effective cryopreservation device for cryo-bag with a good cooling rate. The present invention offers a cryopreservation device for cryo-bag with a low cost, an optimal cooling rate for massive cells preservation. In this device, cells in cryo-bag after large scaled culture expension with long term cryopreservation keep a good viability after thawing.

Accordingly, the present invention relates to a cryopreservation device for cryo-bag under slow cooling. The device comprise a main body case, one or more layers of spaces for cryo-bag insertion, and two or more Teflon cryopreservation bags filled with isopropanol. The term “cryo-bag” or “cell collection bag” described in the present invention is defined as a cryogenic preservation bag containing viable cells. As used herein, the viable cells can be cells after in vitro culture expansion, including (but not limited to) stem cells, or the cord blood harvested from a living body.

In order to avoid contamination and be favorable for transportation and stacking, a cover lid on the main body case of the cryopreservation device for controlling open and close by pressing-fit or snapping-fit. The main body case can be made of freeze-resistant plastic, paper, metal or other materials, and the material is not particularly limited in the present invention. One of the embodiments in the present invention is that the main body case and the cover lip are made of a PP plastic material.

The cryopreservation device of present invention contains a single- or multi-layer of placing space for cryo-bags. The cryo-bags can be placed in an individually removable metal case, or be set on a clapboard held by protruded objects from the inner wall of the main case. The height of the placing space should be the same as that of the cryo-bag to make sure that cryo-bag directly contact with the Teflon cryopreservative bags on the upper and lower surfaces.

Isopropyl alcohol is one of the choice used as a refillable cryoprotectant in the Teflon cryopreservative bag. The size of the bag should match the length and width of the inner edges of space for Teflon cryopreservative bag. The weight (g)/area (cm²) ratio of the cryopreservative bag is preferably from 0.7 to 0.9, considered for a better loading capacity.

Preferably, the cryo-bags are intermediately stacked between the Teflon cryopreservative bags. In a better embodiment of the present invention, both upper and lower surfaces of the cryo-bag directly contact with the Teflon cryopreservative bags.

In another aspect, the present invention relates to a method for large-scale cell cryopreservation comprising: culture expended cells or cord blood in a cryo-bag; placing a Teflon cryopreservative bag filled with cryoprotectant at the bottom of the present invented cryopreservation device; setting a layer of placing space for cryo-bags on the upper side of the Teflon cryopreservative bag; placing the cryo-bags in the space; stacking a Teflon cryopreservative bag on the top of the cryo-bags; optionally repeating the setting and stacking procedures of cryo-bags and Teflon cryopreservative bag for 2 times or more; sealing the cryopreservation device and be cooled at −80° C. for 6-10 hours. Preferably, the cryopreservation device is placed into the liquid nitrogen tank for long term preservation when the temperature has dropped to −80° C.

### BRIEF DESCRIPTION OF THE DRAWINGS

FIG. 1A shows a transparent view of one example of the cryopreservation device of the present invention. FIG. 1B shows the schematic diagram of its main component—the Teflon cryopreservative bag.

FIG. 2 shows a cross-sectional view of the cryopreservation device. The cryo-bags and cryopreservative bags are stacked with a Sandwich method.

FIG. 3 shows the optimal curve of cell freezing process (Reference: Transfus Med Rev. 1997 July; 11(3):224-33).

FIG. 4A shows time-dependent temperature curve in a sandwich of the cryopreservative bags without cryo-bag in the cryopreservation device. Data collected from two different layers of the empty spaces and surfaces of different cryopreservative bags labeled in red. FIG. 4B shows time-dependent temperature curve in a sandwich of the cryopreservative bags with cryo-bag in the cryopreservation device. Data collected from two different layers of the cryo-bags and surfaces of different cryopreservative bags labeled in red.

FIG. 5 shows time-dependent temperature curve in cryo-bag stacking method without separating by a cryopreservative bag. Data collected from two different layers of the cryo-bags and surfaces of different cryopreservative bags labeled in red.

FIG. 6A shows the comparison of mesenchymal stem cell (MSC) viability (%) cryopreservated under a sandwich method (FIG. 4B) and under a stacking method (FIG. 5) after thawing. FIG. 6B demonstrates the morphology of the MSCs on a culture plate after cryopreservated in the present invention with a sandwich method.

FIGS. 7A-7C show a good tri-linage differentiation capacity (capability of differentiating into osteoblasts, chondrocytes, and fat cells) of MSCs after cryopreservated in the present invention with a sandwich method. FIG. 7A-C illustrate the results from three different donors.

### DETAILED DESCRIPTION OF THE INVENTION

The other characteristics and advantages of the present invention will be further illustrated and described in the following examples. The examples herein are used for illustrations only, not for limiting the usage of the present invention.

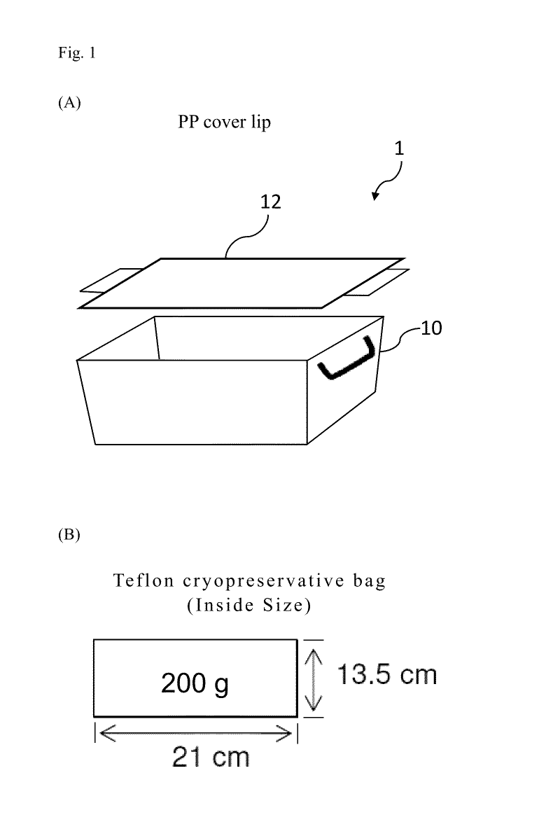

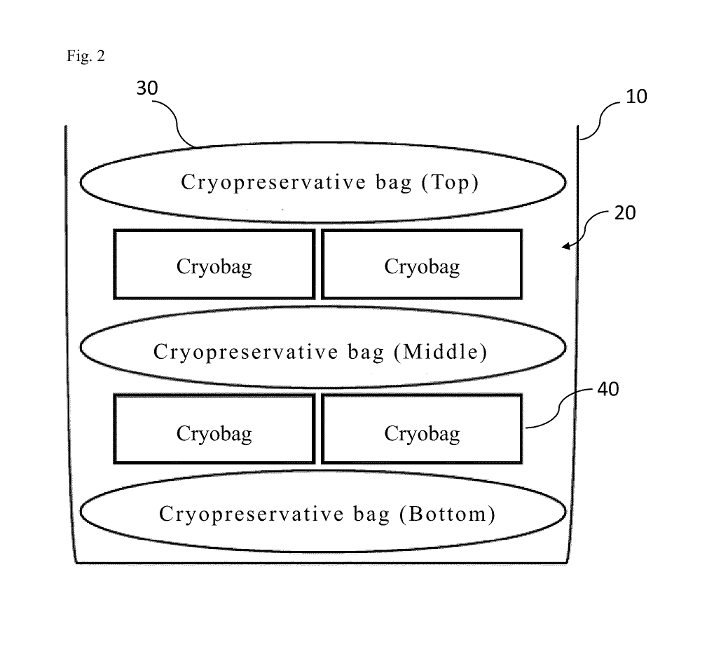

Firstly, FIGS. 1 and 2 show a detailed structure of the cryopreservation device 1 of present invention. As shown in FIG. 1, the present invention comprises a main body case 10, single- or multiple-layers of space for cryo-bags 20, and two or more Teflon cryopreservative bags 30. The main body case 10 has a cover lip 12 for opening and closing. The spaces for cryo-bags 20 may be designed to house two or more cryo-bags. The Teflon cryopreservative bag is filled with a cryoprotectant (preferably, isopropyl alcohol), and is stacked at each layer for contacting directly with top and bottom surface of the cryo-bags.

For an optimal cryopreservation, the inner capacity of the main body case 10 can store at least two layers of the cryo-bags and three Teflon cryopreservative bags 30. In this example of cryopreservative device 1, the optimal upper limit of loading capacity for the cryo-bags 40 is 4. The space 20 for the single layer of the cryo-bag 40 is up to 2. The size of the Teflon cryopreservative bag must well fit with the inner edge of the main body. The Teflon cryopreservative bag 30 is filled with the cryoprotectant (100% isopropyl alcohol is known as a better one), wherein the ratio of the amount of cryoprotectant to the area of the Teflon cryopreservative bag 30 is 0.70.9 (g/cm²). For example, the Teflon cryopreservative bag 30 with the inner edge 21 cm×13.5 cm can be filled with 200 g of 100% isopropanol.

An exemplary assembling and using method of the cryopreservation device 1 for cell freezing is described. Firstly, pre-cooling the Teflon cryopreservative bags 30 in a ˜−30° C. refrigerator for 2.5 hours or more. Place a cell collection bag into a pincer (hereinafter simply referred to as this combination “CryoBag”), and temporarily stored in a 4° C. refrigerator. After all the cryo-bags 40 are prepared, the present cryopreservation device 1 is assembled in a sandwich method with intermediate stacking of the Teflon cryopreservative bags 30 and the cryo-bags 40 , as shown in FIG. 2, wherein the present invention shows that the Teflon cryopreservative bags 30 are placed on the top and the bottom of cryo-bag 40. The cryo-bags 40 are placed between the Teflon cryopreservative bags 30, which are able to directly contact the Teflon cryopreservative bags 30 on both sides. The Teflon cryopreservative bags 30 can be horizontally placed on a single-layer of the cryo-bag 40. The maximum number is up to two cryo-bags 40 for each single layer. Make sure that cryo-bags 40 should force evenly on the Teflon cryopreservative bags 30. After completion of stacking the Teflon cryopreservative bags 30 and the cryo-bag 40, the case 10 can be covered with the cover lip 12. The cover lip 12 and the main body case 10 should be tightly connected in a press-fit or snap-fit method. After completion of stacking, the cryo-bags 30 sealed in the cryopreservation device 1 are placed at −80° C. refrigerator for more than 6 hours, preferably 6-10 hours, to gradually cool down to −80° C., before they can be moved into the liquid nitrogen tank for long term preservation.

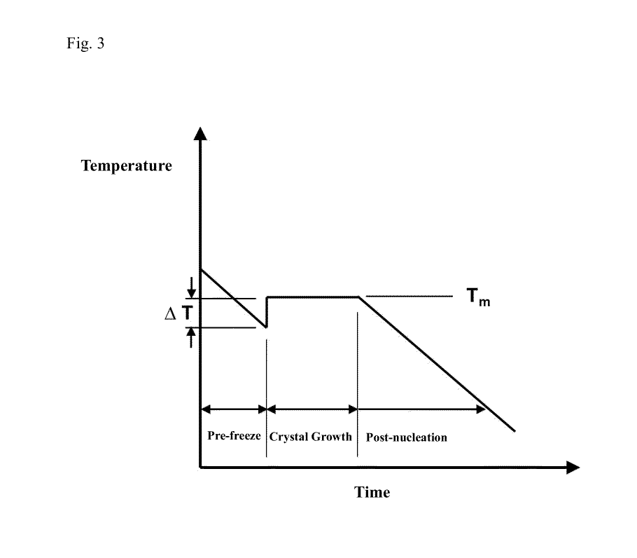

Cells should be frozen under a slow cooling process, so the water inside the cell will not condense into un-regular crystal and then be damaged. The optimal rate for preventing toxic crystallization is −1° C. /min. The standard temperature decreasing curve (STD) is described in FIG. 3 (Adopted from Transfus Med Rev. 1997 July; 11 (3):224-33).

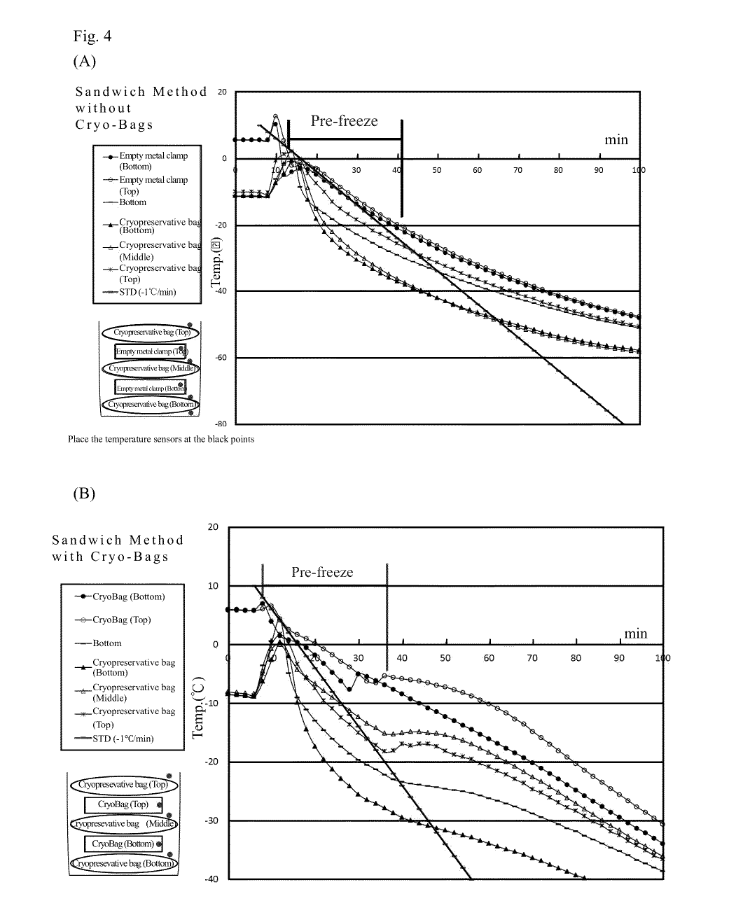

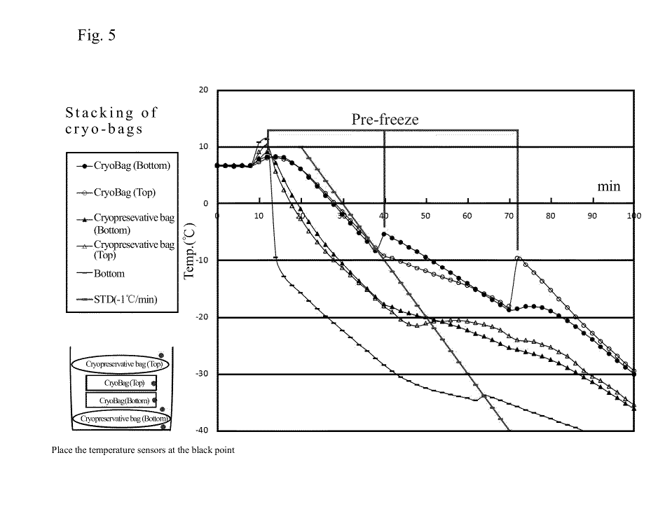

Therefore, the cooling curves of the cryopreservation device 1 assembled using the sandwich method as described in the present invention (hereinafter referred to as sandwich method) and the other stacking method are obtained to investigate and understand the frozen effect of the present invention cryopreservation device 1. For the cooling process using the sandwich method, the cooling curve of the two layers without placing the cryo-bags are the same. The temperature in STD decrease −1° C./min, as shown in FIG. 4A. The device 1 using the sandwich method for stacking the Teflon cryopreservative bags shows a short heat-releasing time from the cryo-bags in the two layers. The temperature difference (ΔT) is small and range from 1.62˜6° C. Although the cooling rate is slightly slower than that in the STD, the sandwich method preserves a large number of cells well in the cryo-bags. The second layer of the cryo-bags 40 shows the same phenomena, which has slow cooling rate and small heat releasing difference, as shown in FIG. 4B. FIG. 5 shows that the two layers of the cryo-bags are stacked directly and then the Teflon cryopreservative bags are placed on the top and the bottom of them. As shown in the cooling curves in FIG. 5, stacking with two layers of cryo-bags reveals a longer heat-releasing time and a larger heat-releasing temperature difference than a sandwich method during the cooling process. This indicates the sandwich method is better than the direct stacking method.

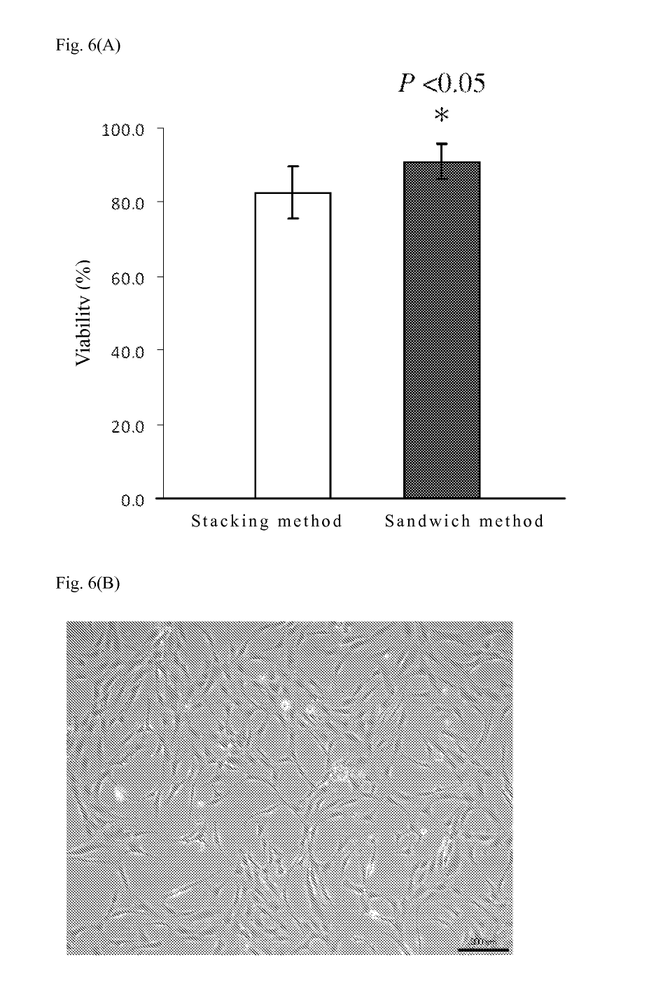

The cell viability (%) of MSCs frozen with the sandwich method of present invention and a direct stacking method under −80° C. liquid nitrogen preservation is compared. The result shows that, after thawing, MSCs preserved by the sandwich method significantly demonstrate a better survival rate (90.89%) than the direct stacking method, as shown in FIG. 6A. The observations of the cell morphology in FIG. 6B show that after cryopreservation in the present cryopreservative device by a sandwich method, MSCs cultured in the petri-dish for 3 days still retain their attached growth characteristics and healthy appearance after recovery.

Using the cryopreservation method of the present invention for MSCs, after thawing, the surface phenotypes for MSCs are analyzed. The cells are stained with the specific antibody with a fluorescent dye using a flow cytometry to detect whether the cells have a particular tag MSC performance (markers), and the cells show a high purity of MSCs for clinical use as shown in Table 1.

TABLE 1

| Sandwich | | | | |
|---|---|---|---|---|
| method (SW) | Cell surface antigen expression | | | |
| Batch | CD 105+ | CD 90+ | CD 73+ | Negative cocktail |
| SW01 | 99.84% | 99.96% | 99.75% | 0% |
| SW02 | 99.12% | 99.95% | 99.82% | 0% |
| SW03 | 95.12% | 96.87% | 96.67% | 0% |

| | | |
|---|---|---|
| ISCT Definition | >95% | <2% |

The results show that the expression of CD105, CD90, and CD73 of three batches MSC cells have a population greater than 95%. The cell population is greater than 98% without showing negative Cocktail markers (CD45, CD34, CD14 or CD11b, CD79 a or CD19, HLA-DR), which indicates the negative markers expression <2%. The results are in compliance with International Society for Cellular Therapy (ISCT) as defined by Mesenchymal Stromal Cells (MSCs) of antigen expression (according to the definition of the MSC ISCT conditions refer Cytotherapy (2006) Vol. 8, No. 4, 315-317).

As the thawed MSCs are attached to the petri-dish, they are induced to differentiate into “osteoblasts”, “chondrocytes” and “adipocytes”, respectively. The cell differentiation is identified using kinds of staining methods as listed in Table 2. The staining methods and the coloring results in osteoblasts, chondrocytes and adipocytes are shown in the Table 2.

TABLE 2

| Differentiation | Identification of | | | Differentiation |
|---|---|---|---|---|
| of species | target | Staining method | Staining result | capacity |
| Osteoblasts | Alkaline | Nitro blue | Violet | 2 Positive |
| | phosphatase | tetrazolium-5- | | |
| | | bromo-4-chloro-3- | | |
| | | indolyl phosphate | | |
| | Calcium ion | Alizarin Red | Orange | |
| Chondrocytes | Aggrecan | Alcian blue | Cells formed | Positive |
| | | | ball-shaped, blue | |
| Adipocyte | Oil droplets | Oil red | Cells with red oil | Positive |
| | | | droplets | |

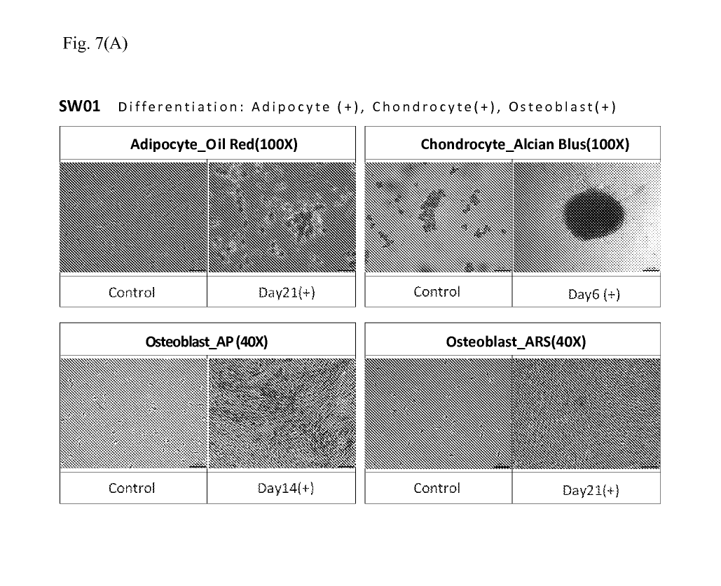

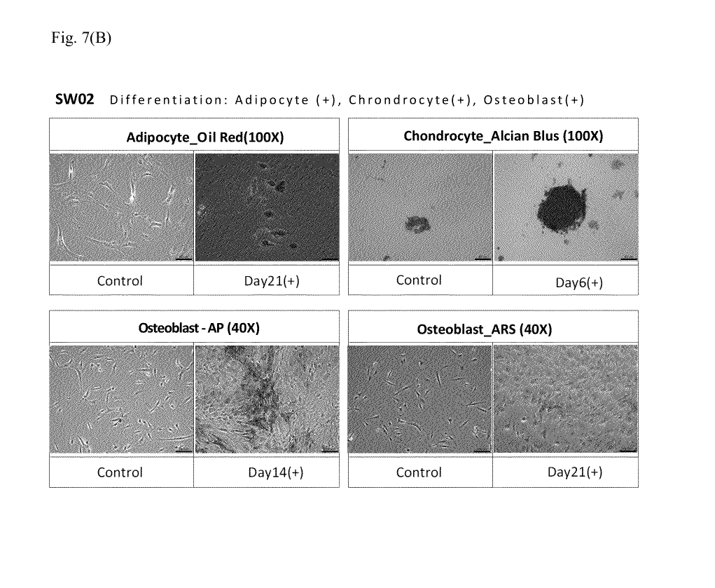

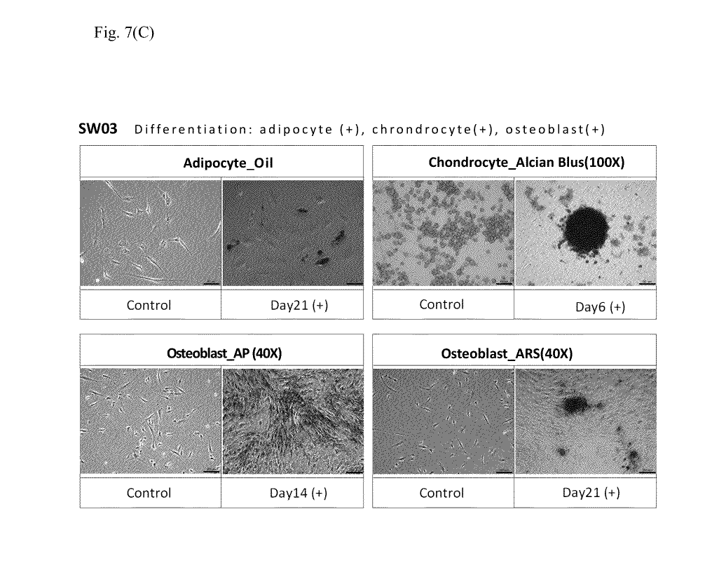

FIG. 7 shows the differentiation of three batches (SW01, SW02, SW03) of frozen MSCs into osteoblasts, chondrocytes and adipocytes. The results are in compliance with ISCT as defined in the human mesenchymal stem of tri-lineage differentiation capacity.

From the above measurement results, compared with a method of stacking cryo-bags, the cryopreservation device of present invention (a sandwich method) provides a better way for massive cell cryopreservation. It leads a large number of cells in the cryo-bags maintaining a good survival rate (90.89%). Moreover, using the present invention cryopreservation device for MSC cell collection bags, the MSCs still possess multi-potent characteristics and differentiation capacity after thawing, which are in compliance with ISCT release for clinical use of the MSC standard.

1. A cryopreservation device for cell collection bag (cryo-bag), comprising:
a main body case with a capacity for containing the cryo-bags and the components of the device, wherein the main body case is equipped with a cover lip for sealing after the completion of assembling the cryopreservation device;
one or more layers of space for cryo-bags; and
two or more Teflon cryopreservative bags for contacting with the cryo-bags, wherein the Teflon cryopreservative bag is filled with a freezing resistant to achieve the temperature-decreasing rate of the cryo-bags approximately −1° C./min.

2. The cryopreservation device of claim 1, wherein the freezing resistant filled in the Teflon cryopreservative bag is isopropyl alcohol.

3. The cryopreservation device of claim 1, wherein the Teflon cryopreservative bags are crossly stacked from the bottom to the top in the cryopreservation device.

4. The cryopreservation device of claim 3, wherein the top and the bottom sides of the cryo-bag are contacted directly with the Teflon cryopreservative bags, respectively.

5. The cryopreservation device of claim 1, wherein the cover lip is used to seal the cryopreservation device in a press-fit method.

6. The cryopreservation device of claim 1, wherein the cover lip is used to seal the cryopreservation device in a snap-fit method.

7. A cryopreservation method for cry-bag, comprising:
collecting viable cells or cord blood in a cell collection bag;
placing a Teflon cryopreservative bag which is filled with a freezing resistant at the bottom of the main body case of the cryopreservation device of claim 1;
setting a layer of placing space for cryo-bags on the upper side of the Teflon cryopreservative bag and placing the cryo-bag with viable cells or cord blood into the space;
stacking a Teflon cryopreservative bag on the top of the cryo-bags;
repeating the setting and stacking procedures of the space for cryo-bags and the Teflon cryopreservative bag for 2 times or more;
sealing the cryopreservation device with a cover lip and be cooled at −80° C. for 6-10 hours; and
optionally, placing the cryopreservation device into the liquid nitrogen tank for long term preservation when the temperature has dropped to −80° C.

8. The cryopreservation method of claim 7, wherein the temperature decreases approximately 1° C./min for the cryo-bag in the cryopreservation device.

9. The cryopreservation method of claim 7, wherein the cultured cells are stern cells.
